(19) United States
(12) Patent Application Publication
(10) Pub. No.: US 2004/0189920 A1
(43) Pub. Date: Sep. 30, 2004

(54) IPS liquid crystal display with conductive spacers

(76) Inventors: Tsau-Hua Hsieh, Miao-Li (TW); Jia-Pang Pang, Miao-Li (TW); Cheuh-Ju Chen, Miao-Li (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/812,566

(22) Filed: Mar. 29, 2004

(30) Foreign Application Priority Data
Mar. 28, 2003 (TW) 092107178

(51) Int. Cl. G02F 1/1343

(52) U.S. Cl. 349/141

(57) ABSTRACT

An IPS (in-plane switching) liquid crystal display (2) has a first substrate (23), a second substrate (24) opposite to the first substrate, a liquid crystal layer disposed between the two substrates, a plurality of common electrodes (25) and pixel electrodes (26) disposed on the second substrate, and a plurality of spacers (29) disposed on the common electrodes and the pixel electrodes. The spacers are electrically conductive. The liquid crystal layer, together with the electric field generators comprising the electrodes and the spacers connected with them, cooperatively form a “functionally unified” configuration. Accordingly, liquid crystal molecules (27) in the liquid crystal layer are in a strong electric field having a highly uniform direction. The strong electric field enables the IPS type liquid crystal display to operate on a lower driving voltage, and/or to provide more space between the electrodes to yield a higher aperture ratio.

### BACKGROUND OF THE INVENTION

1. Field of the Invention

The present invention relates to an IPS LCD (in-plane switching liquid crystal display) having conductive spacers. The instant application relates to a contemporarily filed application title “IN PLANES SWITCHING LIQUID CRYSTAL DISPLAY”, and having two common inventors with the instant invention.

2. Description of Prior Art

In a conventional liquid crystal display, a pair of facing transparent electrodes is respectively formed on each of two substrates, and is used for driving a liquid crystal layer between the substrates. In such a device, a displaying means known as a TN (twisted nematic) display is adopted. That is, the liquid crystal display operates by being supplied with an electric field having a direction orthogonal to inner surfaces of the substrates.

However, the TN mode LCD has a narrow viewing angle, which means that the quality of the display greatly depends on the direction of viewing. In order to obtain a wide viewing angle, the IPS (in-plane switching) type LCD has been developed.

U.S. Pat. No. 5,600,464 issued on Feb. 4, 1997 discloses an IPS type liquid crystal display, which is represented in FIG. 6 and designated therein with the numeral 1. FIG. 6 is a schematic, side cross-sectional view of a cell of the LCD 1 under no voltage. FIG. 7 is a front elevation of the LCD 1 corresponding to FIG. 6. Signal electrodes 16 and a common electrode 15 are formed in sequence at an inner side of the substrate 12, and an orienting film 100 is provided to align liquid crystal molecules 17. A pair of upper and lower polarizers 13, 14 is formed at outer sides of the transparent substrates 11, 12, respectively. Bar-shaped liquid crystal molecules 17 of positive dielectric anisotropy are held between the two substrates 11, 12.

Referring to FIG. 7, a polarization direction 130 of the upper polarizer 13 is orthogonal to a polarization direction 140 of the lower polarizer 14. The orienting film 100 has an aligning direction parallel to the polarization direction 140 of the lower polarizer 14. When no voltage is supplied, due to the aligning function of the orienting film 100, a longitudinal direction 170 of the liquid crystal molecules 17 is parallel with a transmission axis of the lower polarizer 14. Polarized light beams passing the lower polarizer 14 can transmit through the liquid crystal molecules 17 and reach the upper polarizer 13. Because the polarization direction 130 of the upper polarizer 13 is orthogonal to the polarization direction of the polarized light, no light beams pass through the upper polarizer 13.

FIG. 8 is a schematic, side cross-sectional view of the cell of the LCD 1 when a voltage is applied. FIG. 9 is a front elevation of the LCD 1 corresponding to FIG. 8. When the voltage is applied, the linear signal electrode 16 and common electrode 15 generate an electric field 18. The electric field 18 is substantially parallel to the substrates 11, 12, and has a direction located between the two polarization directions 130, 140. The liquid crystal molecules 17 are oriented to have the same direction as that of the electric field 18. Therefore only part of the light beams passing the lower polarizer 14 transmit through the liquid crystal molecules 17, and only part of the light beams reaching the upper polarizer 13 pass through it.

Referring to FIG. 8, because the signal electrode 16 and the common electrode 15 are both disposed on the lower substrate 12, the electric field 18 generated between the electrodes 15, 16 has an arched form in the region where the liquid crystal molecules 17 are located. That is, even though the liquid crystal molecules 17 lie in a same plane parallel with the lower substrate 12, they have different orientations according to the varying electric field driving them. This variation in orientations reduces the clarity of the display of the LCD 1. Furthermore, the intensity of the electric field 18 decreases with increasing distance away from the lower substrate 12. Accordingly, to drive the liquid crystal molecules 17, a higher driving voltage between the electrodes 15, 16 must be employed, and/or a shorter distance must be configured between the electrodes 15, 16. This results in higher power consumption and/or a lower aperture ratio.

It is desired to provide an IPS type liquid crystal display which overcomes the above-described deficiencies.

### SUMMARY OF THE INVENTION

An object of the present invention is to provide an IPS type liquid crystal display having a low driving voltage, a high aperture ratio, and a good display.

A first embodiment of an IPS type liquid crystal display of the present invention comprises a first substrate, a second substrate opposite to the first substrate, a liquid crystal layer disposed between the two substrates, a plurality of common electrodes and pixel electrodes disposed on the second substrate, and a plurality of spacers disposed on the common electrodes and the pixel electrodes. The spacers are electrically conductive.

A second embodiment of an IPS type liquid crystal display of the present invention comprises a first substrate, a second substrate opposite to the first substrate, a liquid crystal layer disposed between the two substrates, a plurality of common electrodes and pixel electrodes disposed on the second substrate, a plurality of spacers disposed on the common electrodes and the pixel electrodes, and a plurality of counter electrodes disposed between the spacers and the first substrate. Each spacer comprises a spacer body, and an electrically conductive film around the spacer body.

Because conductive spacers are connected with the common electrodes and pixel electrodes, when a voltage is supplied to the electrodes, an electric field is generated by the electrodes and the spacers. Unlike in a conventional LCD where the liquid crystal molecules are merely above the electrodes that generate the driving electric field, the liquid crystal molecules of the present IPS type liquid crystal display are between two spacers that also generate the driving electric field. That is, the liquid crystal layer, together with the electric field generators comprising the electrodes and the spacers connected with them, cooperatively form a “functionally unified” configuration. Accordingly, the liquid crystal molecules are in a strong electric field having a highly uniform direction. The strong electric field enables the IPS type liquid crystal display to operate on a lower driving voltage, and/or to provide more space between the electrodes to yield a higher aperture ratio. The uniform electric field enables the display of the IPS type liquid crystal display to be clearer.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a schematic, cross-sectional view of an IPS type LCD according to the first embodiment of the present invention, showing the LCD in an off state;

FIG. 2 is a cross-sectional view of a spacer of the LCD of FIG. 1, taken along line II-II thereof;

FIG. 3 is similar to FIG. 1, but showing the LCD in an on state;

FIG. 4 is a schematic, cross-sectional view of an IPS type LCD according to the second embodiment of the present invention, showing the LCD in an on state;

FIG. 5 is a cross-sectional view of a spacer of the LCD of FIG. 4, taken along line V-V thereof;

FIG. 6 is a schematic, side cross-sectional view of a conventional IPS type liquid crystal display, showing the LCD in an off state;

FIG. 7 is a front elevation of the LCD of FIG. 6;

FIG. 8 is similar to FIG. 6, but showing the LCD in an on state; and

FIG. 9 is a front elevation of the LCD of FIG. 8.

### DETAILED DESCRIPTION OF THE INVENTION

Referring to FIG. 1, an IPS liquid crystal display 2 according to a first embodiment of the present invention comprises a first substrate 21, a second substrate 22 opposite to the first substrate 21, a liquid crystal layer (not labeled) disposed between the two substrates 21, 22 and comprising twisted nematic liquid crystal molecules 27, an alignment film 200 disposed on the second substrate 22 for aligning the liquid crystal molecules 27, an upper polarizer 23 and a lower polarizer 24 disposed at outer sides of the two substrates 21, 22 respectively, a plurality of common electrodes 25 and pixel electrodes 26 disposed on the second substrate 22, and a plurality of electrically conductive spacers 29 disposed on the common electrodes 25 and the pixel electrodes 26.

The alignment film 200 has an aligning direction parallel with a polarization direction of the lower polarizer 24. The upper polarizer 23 has a polarization direction 23 orthogonal to that of the lower polarizer 24. In an off state, when no voltage is supplied to the electrodes 25, 26, liquid crystal molecules 27 have an orientation parallel with the polarization direction of the lower polarizer 24. Thus, polarized light beams passing through the lower polarizer 24 can transmit through the liquid crystal layer. Because the polarization direction of the upper polarizer 23 is orthogonal to that of the lower polarizer 24, the light beams reaching the upper polarizer 23 cannot pass therethrough, and the display of the LCD 2 is dark.

Referring to FIG. 2, each spacer 29 has a rectangular cross-section. The spacer 29 can be made of an ACF (anisotropic conductive film), or of a metal like gold, silver, copper, etc.

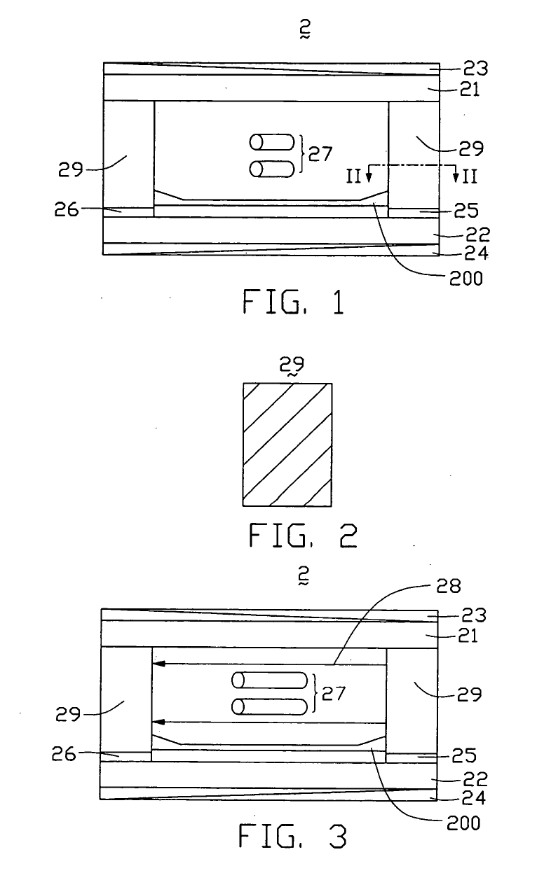

Referring to FIG. 3, in an on state, a voltage is applied to the electrodes 25, 26, and an electric field 28 is generated between the electrodes 25, 26 and the spacers 29 connected with them. The electric field 28 has a direction located between the two polarization directions of the two polarizers 23, 24, and the liquid crystal molecules 27 change their orientation to be in the direction of the electric field 28. Therefore part of the light beams passing the lower polarizer 24 transmit through the liquid crystal molecules 27, with the polarization direction of the transmitted light beams being changed. Then part of the light transmitted light beams reaching the upper polarizer 23 pass through it and emit out.

The electric field 28 is generated not only by the common electrode 25 and pixel electrode 26, but also by the conductive spacers 29. The liquid crystal layer, together with the electric field generators comprising the two electrodes 25, 26 and the spacers 28 connected with them, cooperatively form a “functionally unified” configuration. Such a configuration provides a more uniform, stronger electric field to drive the liquid crystal molecules 27, compared with the prior art liquid crystal display that merely has the liquid crystal layer located above the electric field generators. Thus the LCD 2 allows a lower driving voltage to be used, and/or a larger space to be configured between the common electrode 25 and the pixel electrode 26. By using a lower driving voltage, power consumption can be lowered. By increasing the space between the two electrodes 25, 26, a higher aperture ratio can be obtained. Due to the uniform electric field, the display of the LCD 2 is clearer.

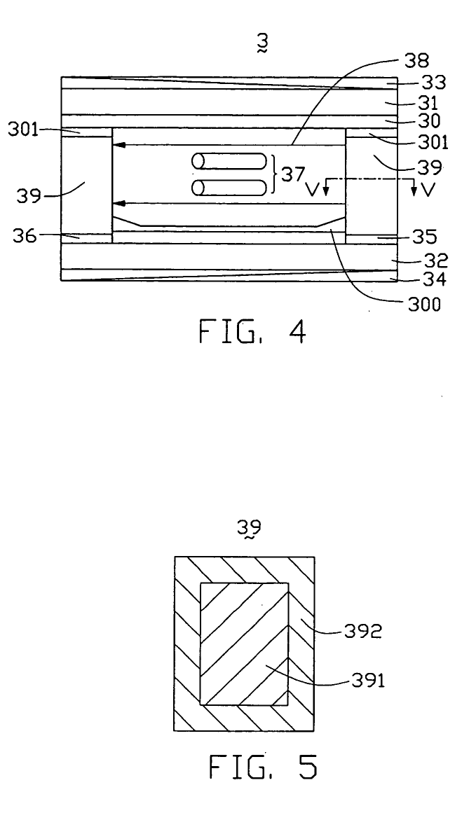

Referring to FIG. 4, an IPS liquid crystal display 3 according to a second embodiment of the present invention comprises a first substrate 31, a second substrate 32 opposite to the first substrate 31, a liquid crystal layer (not labeled) disposed between the two substrates 31, 32 and comprising twisted nematic liquid crystal molecules 37, an alignment film 300 disposed on the second substrate 32 for aligning the liquid crystal layer, an upper polarizer 33 and a lower polarizer 34 disposed at outer sides of the two substrates 31, 32 respectively, a plurality of common electrodes 35 and pixel electrodes 36 disposed on the second substrate 32, a plurality of conductive spacers 39 disposed on the common electrodes 35 and the pixel electrodes 36, a color filter 30 disposed under the first substrate 31 for providing a color display, and a plurality of counter electrodes 301 respectively disposed between the spacers 39 and the color filter 30.

The LCD 3 operates according to the same principles as described above in relation to the LCD 2. In an on state, the common electrodes 35, the pixel electrodes 36, the spacers 39 and the counter electrodes 301 generate an electric field 38 to change the orientation of the liquid crystal molecules 37.

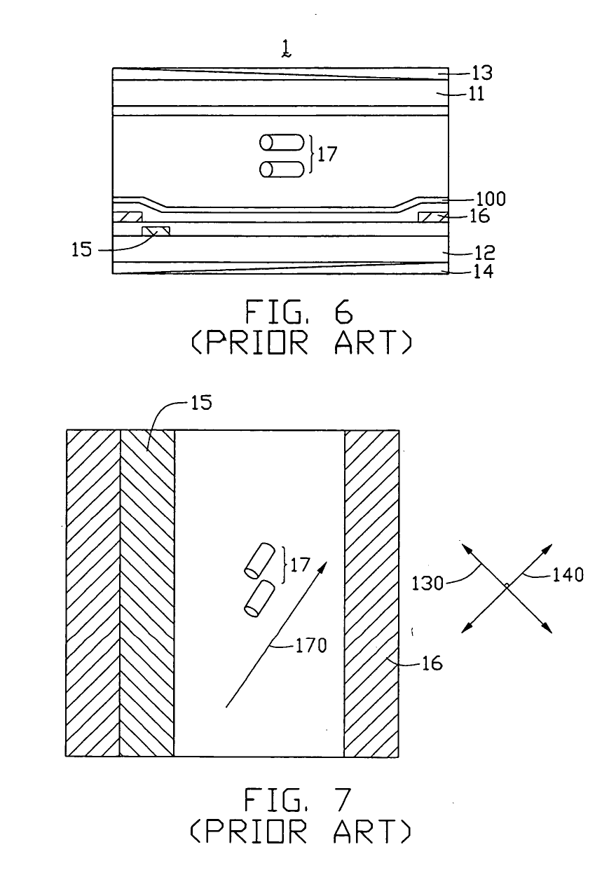

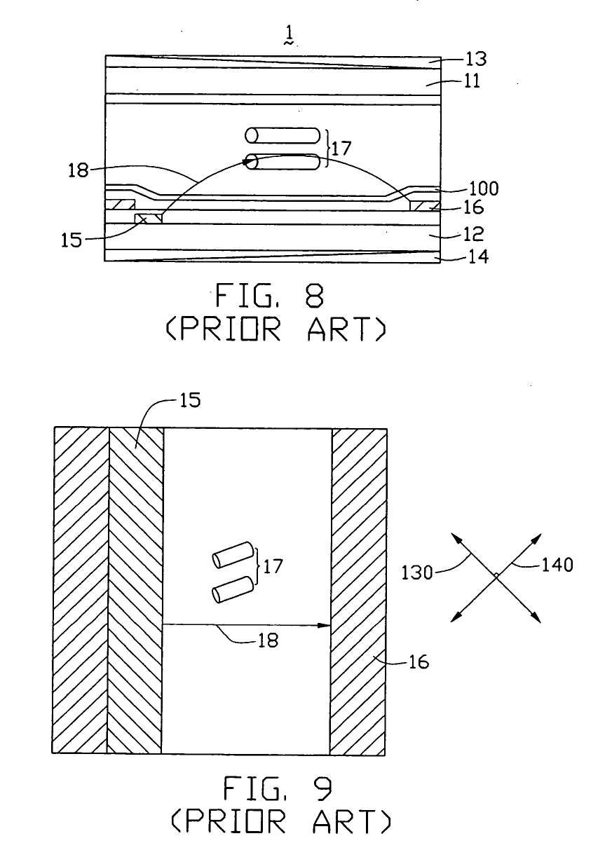

Referring to FIG. 5, each spacer 39 comprises a spacer body 391 and an electrically conductive film 392 around the spacer body 391. The spacer body 391 is made of glass, and the conductive film 392 is made of indium-tin oxide.

Similar to the LCD 2, the LCD 3 has a “functionally unified” configuration. In particular, the electric field generators additionally comprise the counter electrodes 301. The advantages of the LCD 3 are similar to those of the LCD 2; that is, a lower driving voltage, a higher aperture ratio, and a clearer display.

In both the LCD 2 and the LCD 3, the substrates 21, 22, 31, 32 can be made of glass or silicon dioxide. In alternative embodiments, the cross-section of each spacer 29, 39 can be circular, annular, etc. as needed.

It is also to be generally understood that even though numerous characteristics and advantages of the present invention have been set out in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An IPS (in-plane switching) liquid crystal display, comprising:
a first substrate;
a second substrate opposite to the first substrate;
a liquid crystal layer disposed between the two substrates;
a plurality of common electrodes and pixel electrodes disposed on the second substrate; and
a plurality of spacers disposed on the common electrodes and the pixel electrodes;
wherein the spacers are electrically conductive.

2. The IPS liquid crystal display as claimed in claim 1, wherein the spacers have a rectangular cross-section.

3. The IPS liquid crystal display as claimed in claim 2, wherein the spacers are made of metal.

4. The IPS liquid crystal display as claimed in claim 2, wherein the spacers are made of an ACF (anisotropic conductive film).

5. The IPS liquid crystal display as claimed in claim 1, wherein the spacers have a circular cross-section.

6. The IPS liquid crystal display as claimed in claim 5, wherein the spacers are made of metal.

7. The IPS liquid crystal display as claimed in claim 5, wherein the spacers are made of an ACF (anisotropic conductive film).

8. The IPS liquid crystal display as claimed in claim 1, further comprising a plurality of counter electrodes disposed between the spacers and the first substrate.

9. An IPS (in-plane switching) liquid crystal display, comprising:
a first substrate;
a second substrate opposite to the first substrate;
a liquid crystal layer disposed between the two substrates;
a plurality of common electrodes and pixel electrodes disposed on the second substrate; and
a plurality of spacers disposed on the common electrodes and the pixel electrodes;
wherein each of the spacers comprises a spacer body and an electrically conductive film around the spacer body.

10. The IPS liquid crystal display as claimed in claim 9, wherein each of the spacers has a rectangular cross-section.

11. The IPS liquid crystal display as claimed in claim 10, wherein the spacer body is made of glass.

12. The IPS liquid crystal display as claimed in claim 10, wherein the conductive film comprises indium-tin oxide.

13. The IPS liquid crystal display as claimed in claim 9, wherein each of the spacers has a circular cross-section.

14. The IPS liquid crystal display as claimed in claim 13, wherein the spacer body is made of glass.

15. The IPS liquid crystal display as claimed in claim 13, wherein the conductive film comprises indium-tin oxide.

14. The IPS liquid crystal display as claimed in claim 9, further comprising a plurality of counter electrodes disposed between the spacers and the first substrate.

15. A liquid crystal display comprising:
opposite first and second substrates in a spatial parallel relation;
a liquid crystal layer located between the first and second substrates;
a plurality of spacers located between the first and second substrates and surrounding the liquid crystal layer; and
an alignment film located above the second substrate and under the liquid crystal layer, and horizontally among said spacers.

16. The liquid crystal display as claimed in claim 15, wherein common electrodes and pixel electrodes are located between the corresponding spacers and one of said first and second substrates.

17. The liquid crystal display as claimed in claim 16, wherein counter electrodes are located between the corresponding spacers and the other of said first and second substrates.
